(19) United States
(12) Patent Application Publication
(10) Pub. No.: US 2003/0212607 A1
(43) Pub. Date: Nov. 13, 2003

(54) Method and system for online and feal-time editing and forwarding manifestsza

(75) Inventors: Te-Mei Chu, Taipei (TW); Shu-Mei Chien, Taipei (TW); Yun-Chi Lee, Taipei (TW); Kuan-I Wu, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: INVENTEC CORPORATION, Taipei (TW)

(21) Appl. No.: 10/382,195

(22) Filed: Mar. 4, 2003

(30) Foreign Application Priority Data
May 13, 2002 (TW) 91109871

(51) Int. Cl. G06F 17/60

(52) U.S. Cl. 705/26

(57) ABSTRACT

A system and a method for online and real-time editing and forwarding manifests are proposed in which at least a product flow processing workstation, an order database and a database server are provided, for allowing an authorized user to edit and forward a manifest in an online and real-time manner via Internet. The product flow processing workstation is adapted to establish and store detailed data relevant to product orders in the order database. When the user is linked to the product flow processing workstation, the user can edit the manifest according to practical conditions of product manufacture and demand, and forward the edited manifest via Internet to a buyer who makes a product order in association with the manifest. This facilitates the ease of data inquiry and reduction in repetition of data input from users of the buyer and supplier.

### FIELD OF THE INVENTION

The present invention relates to methods and systems for online and real-time editing and forwarding manifests, and more particularly, to a method and system for online and real-time editing and forwarding manifests, allowing a supplier to respond to orders from a buyer via Internet for product deliveries.

### BACKGROUND OF THE INVENTION

With the rapid changing modern techniques, different kinds of multi-functional products have become daily necessities of human life, such as desk-top personal computers or cellular phones. The above-mentioned high-tech products are composed of electronic components of many different fields and functions, and the so-called production manufacturers in fact merely act as an assembling role, for its relative components are mostly manufactured in an out-sourcing way by other middle-and-down streams suppliers and its satellite factories so as to reduce the production costs and thereby minimize the operation risks.

In proceeding production of the relevant components by out-sourcing, there is required to purchase and order the relevant components from the suppliers; after placing corresponding orders the suppliers then proceed to deliver the goods as specifically ordered.

Generally the delivery operating process is to prepare and deliver the ordered goods to the buyer along with a manifest or even with an invoice.

The foregoing delivery process generally are manually operated, that is, the buyer may inform the seller of its requirements of the goods descriptions and required quantity by means of telephone calls, facsimile transmissions and mails, and after receiving an order from the buyer, in return most sellers will make confirmation of said orders by means of the foregoing methods. However, this accustomed way of doing business is not only time-consuming, but also may result in data changing inadvertently or even loss of data due to different transmission methods adopted therebetween. It is inefficient and impractical to implement in practical operation, and fails to meet the demands of modem trend of speedy, economical and quality services.

Moreover, even there is no faults and defects during data transmissions exchanged between both sides, in the case that a buyer occasionally needs to add or change the sorts and quantities of ordered goods; or at times when a seller is in short of the supplies for the ordered quantity and thus intends to reduce its exportation volume, or even attempts to substitute it with other similar or identical goods in order to satisfy the buyer's demands, all of these changes may affect the whole order and procedures such that the foregoing complicated data transmission process has to be redone again. Therefore, how to foresee the business trend in the changing market often is a crucial element to survive and succeed in keen business competitions. However, even a highly advantageous information can be inadvertently wasted if one cannot be responsive promptly and flexibly to a situation at its first opportunity. It is practically useless to obtain more useful information if one cannot take advantage of the available information promptly and properly. And the foregoing conventional method has this serious drawback, that is, time-ineffective and laborious to implement in practical use.

Moreover, due to convenience and speedy of the modern transportation and the widely accessible of information communication, many large-scale enterprises or manufacturing companies have chosen to establish their own branches and warehouses in different countries in order to integrate and combine the most competitive advantages and factors of each location offered to produce the products; in addition they may directly look for distributed suppliers around the world to seek out the required materials or components at the lowest cost and offer as possible, to thereby achieve an ultimate goal of economical production by reducing costs in every possible way. However, the foregoing conventional methods of proceeding business dealings will more or less be affected by different office hours therebetween if the companies are located in different time zones, it is unlikely to be accomplished in real-time and thus the competitiveness of enterprise-globalization is comparatively diminished as a result.

To address to the foregoing drawbacks of wasting resources and lacking simultaneous responsiveness by conventional manual operation for information communication, the prior art inventions disclosed a method of Electronic Data Interchange (EDI), in short, it is a set of computerized commercial documents (such as purchase order, manifest and invoice) to be used as a standard transmission. Said system is established for the purposes of minimizing paper works and thereby facilitating responding time and process. To enable electronic data interchange system to operate more efficiency, the user needs to follow certain formatted procedures and data-exchanging standards such as X.400 protocol. Although the use of electronic data interchanging system for transmitting commercial documents can save time compared to conventional communication equipment or traditional postal mails, however, as pointed out above, there is certain standardized format procedures for transmitting information to follow, for that purpose a corresponding operational system has to be completed and set up before implementing, thus cannot be widely used by all internet users. Further, although the data sending and receiving procedure is electronized, the actions of sending and receiving electronic data between the buyer and the seller still needs to be carried out and that may lead to further wasting of time and money, as well as more induced errors caused by complicated manual actions.

### SUMMARY OF THE INVENTION

A primary objective of the present invention is to provide a method and a system for online and real-time editing and forwarding manifests over Internet, for allowing the buyers to place purchase orders with detailed descriptions over the internet, and the sellers to check the contents of the purchase order and respond to the requirements of said order in real-time, so as to simplify the process and facilitate handling of commercial shipping documents.

Another objective of the present invention is to provide a method and a system for online and real-time editing and forwarding manifests over Internet, which enable the seller to alter in due time the shipping relevant data such as quantity, packaging method, invoice date and number in response to such modifications made by buyers. Furthermore, in the case of lacking stock of materials or defective goods, sellers can alter the contents of manifest and invoice in real time, to thereby considerably reduce repetition of data-inputting and transmitting time for correcting and delivering said documents to both sides.

Still another objective of the present invention is to provide a method and a system for online and real-time editing and forwarding manifests over Internet, which enable both the buyer and the seller to deliver directly the shipping manifest without having to employ means of Electronic Data Exchange for delivering commercial documents, thereby eliminating complexity of mutual protocol set-up on both sides and facilitating documents correction and transmission by connecting to the internet.

In accordance with the foregoing and other objectives, the present invention proposes a system for online and real-time editing and forwarding manifests over Internet, at least including: a product flow processing workstation, an order database, and a database server.

The product flow processing workstation is provided for the delivery controlling staff to establish an order data file describing the ordered products, in which each data file is provided with an exclusive identification code made according to the suppliers of each order and the delivery site; an order database is provided to store the orders data files established by the product flow processing workstation; and a database server is provided to receive the inquiry information items transmitted from a terminal device, in which the inquiry items include the allocated suppliers' number and delivery site, according to the transmitted information the corresponding data file with detailed information can be obtained through a data searching module preset in the database server to be used by a user at a terminal device. Moreover, the database server further comprises an information correcting module, for allowing the seller to correct the content of its order, and a shipping manifest transmission module enabling the seller to transmit said document to the buyer.

A method for using the system for online and real-time editing and forwarding manifests includes the following steps. First, when said system receives information of a manufacturer number and delivery site inputted by a user of a network terminal device, it prompts an information searching module of the database server to search the database therein for a corresponding data file; subsequently it prompts the database server to display the searched information obtained from the preceding step; and next, the user of a network terminal device can correct the manifest or respond in real-time according to the content of order; lastly, after confirming the details of said order the user can then deliver the shipping manifest to a terminal device on the buyer side over the internet via the shipping manifest delivering module.

By using the method and the system for online and real-time editing and forwarding manifests over Internet, the seller is allowed to be connected to the buyer's web site via the internet for prompt responding or correcting the details of an order, and after confirming the corresponding manifest can be delivered to the buyer instantly, thereby avoiding repetition of data-inputting and reducing cost of transmitting documents back and forth; the proposed method and system further provide a useful functionality for making inquiries of the order in real-time, for allowing the seller to respond immediately to the buyer's demands or inform the seller of the irregular and unexpected situation by means of manifest transmission over the internet.

In summary, the present invention of the method and system for online and real-time editing and forwarding manifests over the Internet enables both the buyer and seller to achieve the objectives of reducing transaction costs and controlling market situation in a real-time manner.

### BRIEF DESCRIPTION OF THE DRAWINGS

The present invention may best be understood through the following description with reference to the accompanying drawings, in which:

FIG. 1 is a block diagram showing the basic architecture of the method and system for online and real-time editing and forwarding manifests according to the invention;

FIG. 2 is a flow chart showing the establishing steps of the orders data base according to the invention;

FIGS. 3(A) to 3(C) are flow charts showing the operational steps involved in using the system and method for online and real-time editing, forwarding and printing manifests according to the invention;

FIGS. 4(A) to 4(C) are schematic diagrams showing the operational steps of an embodiment in practical use, in which a user inquiries the order data and adds a manifest of the system for online and real-time editing and forwarding manifests according to the invention;

FIGS. 5(A) to 5(D) are schematic diagrams showing the operational steps of an embodiment in practical use where a user corrects and duplicates the manifest of the system for online and real-time editing and forwarding manifests according to the present invention; and

FIGS. 6(A) to 6(C) are schematic diagrams showing the operational steps of an embodiment in practical use where a user delivers and prints out a manifest of the system for online and real-time editing and forwarding manifests according to the invention.

### DETAILED DESCRIPTION OF THE PREFERRED EMBODIMENTS

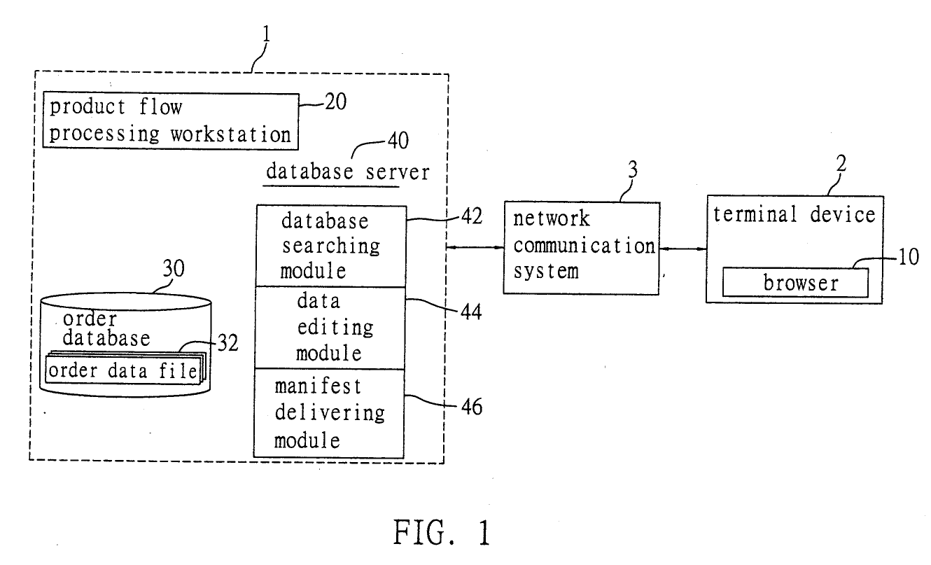

Illustrated in FIG. 1 is a basic configuration of the system and method for online and real-time editing and forwarding manifests of the invention. As shown, the system 1 is provided for allowing a user's computer device 2 through the network communication system 3 to link to the system via a browser 10 to inquiry the required data of an order over the Internet. Said online and real-time manifest correcting and delivering system 1 can be such as a large-scale commercial computer system, and said network communication system 3 can be Internet, an intranet or an extranet for linking to the system 1 for online and real-time manifest correcting and delivering and to its terminal device 2. The said system 1 includes at least a product flow processing workstation 20, an order database 30 and a database server 40.

The product flow processing workstation 20 is provided for allowing the delivery procedural controlling staff to establish an order data file 32 according to each purchased product, and makes an exclusive identification code for each data file at least including information of the supplier of each order and its delivery site, and store the established data file 32 in an order database 30. The product flow processing workstation 20 can be a large-scale commercial computer system capable of interconnecting or integrating with other backstage mainframe systems (not shown, such as an Enterprise Resource Planning; ERP and Material Requirements Planning; MRP).

The order database 30 is provided to store the orders data files 32 established by the product flow processing workstation 20.

The database server 40 is provided for allowing a user of a terminal device 2 to browse and read orders data files 32 stored in the order database 30. When the database server 40 receives an exclusive identification code inputted by a user at a terminal device 2, the database server 40 searches and retrieves a corresponding order data file 32 from the order database 30 therein and delivers the retrieved order data file 32 to the terminal device 2. Moreover, the database sever 40 at least includes a data searching module 42, a data correcting module 44 and a manifest delivering module 46.

The data searching module is used to search a corresponding order data file 32 from the order database 30 therein to provide information for a user at a terminal device.

The data correcting module 44 is provided for the seller to correct the contents of the manifest.

The manifest delivering module 46 is provided for the seller to deliver the manifest to the buyer over the Internet.

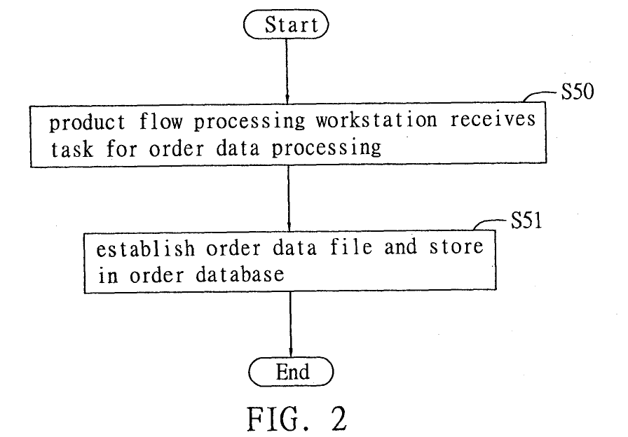

FIG. 2 illustrates a block diagram showing the establishing procedural steps of the order database 30. As shown in Step S50, when the product flow processing workstation 20 receives an order data processing work, it then proceeds to S51; in S51 the product flow processing workstation 20 uses an identification code established by the order data file 32 including at least the supplier's number and its delivery site to store an order data file 32 in the order database 30.

By performing the foregoing steps, the product flow processing workstation 20 accomplishes the order database 32 to enable a user at a terminal device 2 through the network communication system 3 to browse relative information of an order in real time by a browser 10.

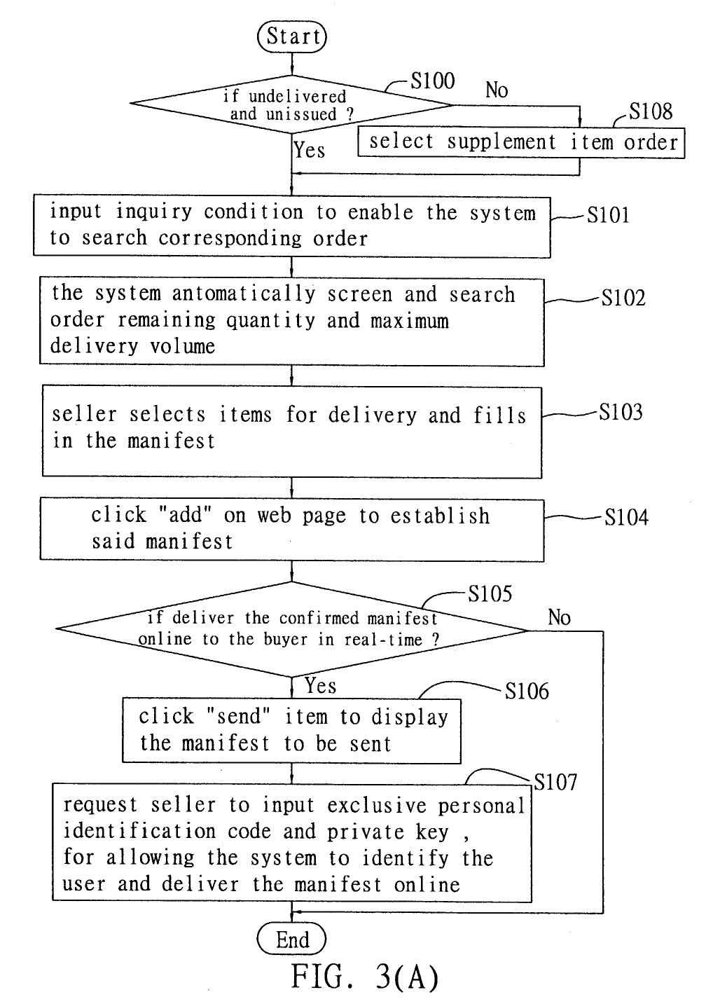

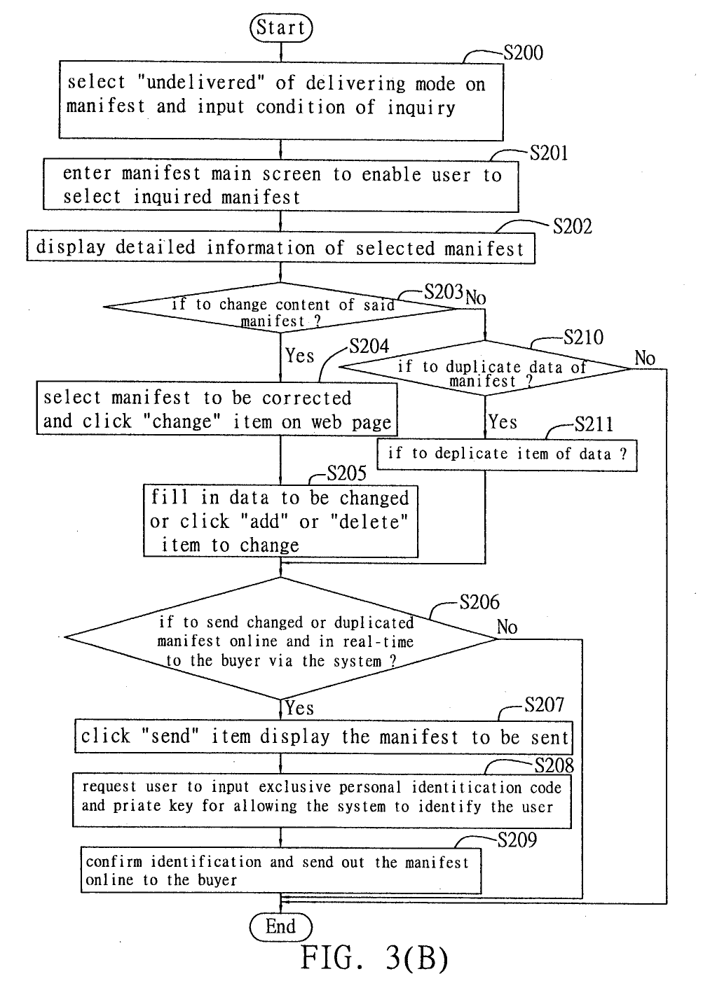

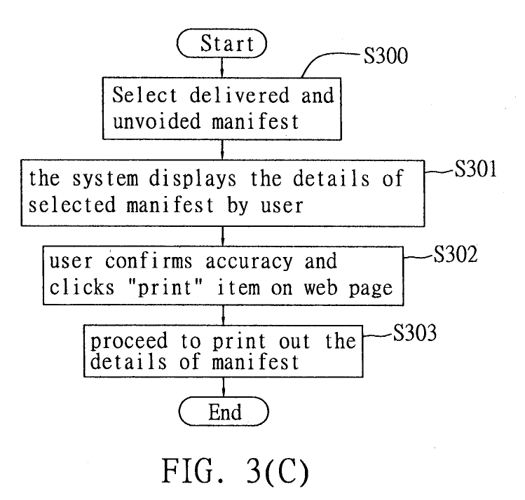

FIG. 3(A) illustrates the method steps involved in using the system of the invention for the seller to deliver the manifest in an on-line and real-time manner. As shown, first, a browser 10 of the user's computer device 2 is linked to a web site server 3 of the system 1 for on-line real-time manifest correcting and delivering over the internet, and subsequently it proceeds to step S100, in which the user needs to check and see if the goods is not delivered and the manifest not issued. If yes, it then proceeds to step S101; if not, proceeds to step S108;

In step S101, the system 1 is initiated to receive the inquiry data input by the user, and accordingly search from the orders data files 32 of the order database 30 therein for a corresponding order data file, it then proceeds to S102;

In step S102, the system 1 is commanded to automatically screen and search the remaining quantity and the maximum delivery volume. Then it moves on to step S103;

In step S1103, the user will select the items of delivery and fill the information in the manifest according to the order. It then proceeds to step S104.

In step S104, the user clicks “add” on the web page to complete the manifest. It proceeds next to step S105.

In step S1105, the user decides if the manifest should be delivered to the buyer online and in real-time over the Internet. If yes, it then proceeds to step S1106; or it ends operation if otherwise.

In step S106, the user clicks “transmit” on the webpage to command the system 1 to print out the manifest. Then it proceeds to S107;

In step S107, the user inputs its exclusive identification code and private key to command the system 1 for identifying the user. If correct, it delivers the manifest online via the Internet and ends the operational steps.

In step S108, the user needs to click the “supplement order” on the webpage and then proceeds to step S101.

By using the foregoing method and steps the supplier can deliver the manifest in an online and real-time manner. FIG. 3(B) illustrates the procedural steps involved in using the system for the user to correct and duplicate the manifest over the Internet. As shown, first, a browser 10 of the user's computer device 2 is linked to a web site server 3 of the system 1 for online and real-time manifest correcting and delivering through the internet, and subsequently it proceeds to step S200.

In step S201, the system 1 enters into a main screen of the manifest for allowing the user to check the manifest, and then it proceeds to step S202;

In step S202, the system 1 is prompted to display detailed information of the manifest, and it proceeds to S203;

In step S203, the system 1 inquires the user if modification of the manifest is required, if yes it proceeds to step S204; if not, it then moves on to step S210;

In step S204, the user select the number of manifest to be altered and clicks “change” item on the webpage, it then proceeds to step S205;

In step S205, the user fills in the information he wishes to change and clicks “add” or “delete” item on the webpage to proceed with modification of manifest, then it proceeds to step S206;

In step S206, the system 1 inquires the user if he wishes to deliver the revised and duplicated manifest to the buyer online and in real-time over the internet, if yes it proceeds to step S207; if not it ends the operation procedure;

In step 207, the user selects and clicks “send” item to prompt the system 1 to display the manifest to be delivered, then it proceeds to S208;

In step S208, the user inputs its identification code and private key to prompt the system 1 to identify the user, then it proceeds to step S209;

In step S209, the system 1 confirms the users' identification and then delivers the manifest to the seller, then it ends said procedural step.

In step S210, the system 1 inquires the user if he wishes to duplicate the content of the manifest, if yes it proceeds to step S211; if not it ends said procedural step.

In step S211, the user chooses the data to be duplicated, then it skips to step S206.

By using the foregoing procedural steps the user can proceed to complete manifest modification and duplication over the Internet in an online and real-time manner.

Illustrated in FIG. 3(C), it shows the procedural steps of a user prints out the manifest online through the Internet. First, a user's browser 10 of a terminal device 2 is linked to the system 1 via the network communication system 3, then it proceeds to S300; in which the user selects the transmitted but not voided manifest on the main web page, then it proceeds to step S301;

In step 301, it prompts the system 1 to display the manifest data selected by the user, then it proceeds to S302;

In step S302, the user confirms accuracy of the displayed manifest and clicks “print” item on the web page, then it proceeds to step S303;

In step S303, the user uses the terminal device 2 to print out the manifest data and ends said procedural step.

By using the foregoing procedural steps the user can proceed to print out the added or revised manifest.

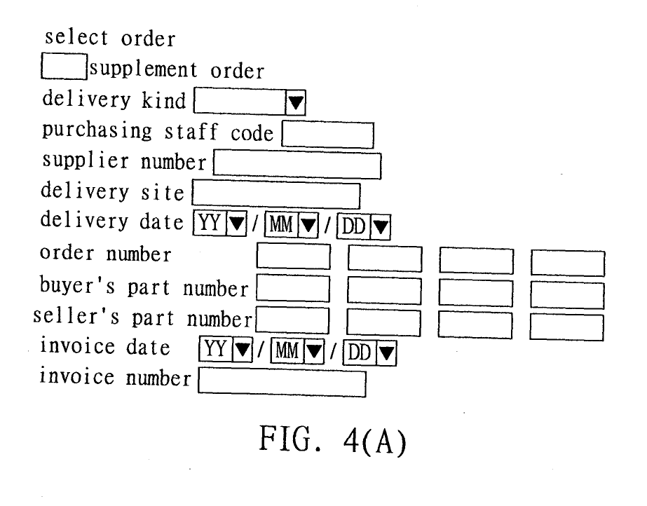

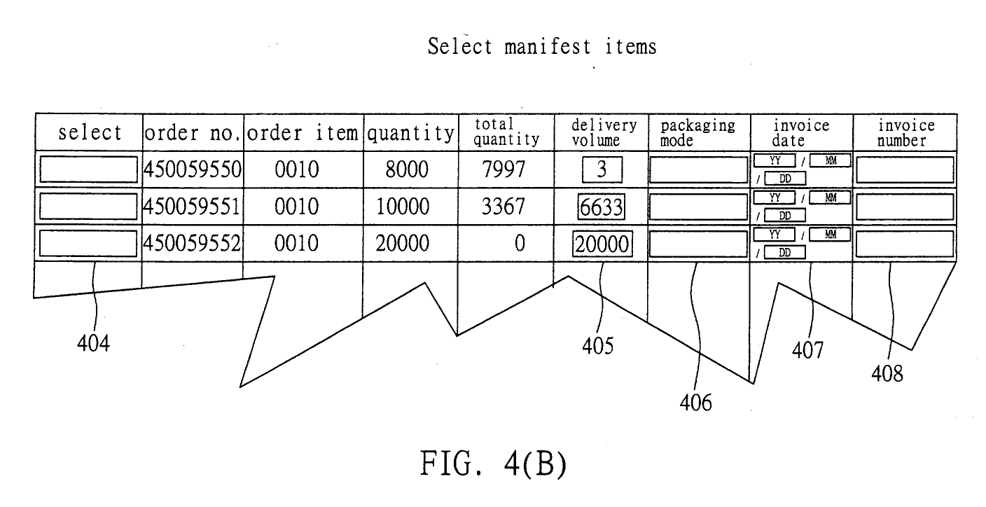

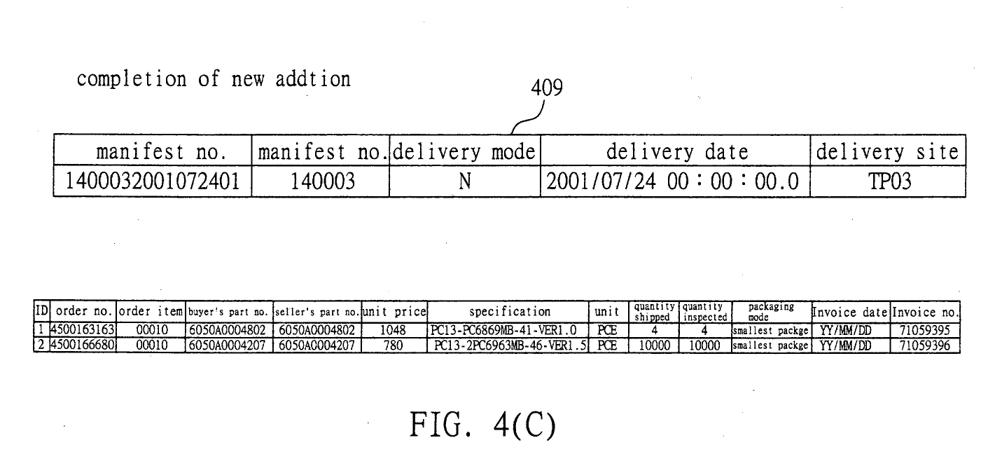

In operation as illustrated in FIG. 4(A), which is a schematic drawing showing the present invention applied to a web page, when a user on the seller side wishes to inquire for detailed content of an order placed by the buyer through the internet, after being connected through the network communication system to enter buyer's established system, subsequently it enters into a web page for selecting orders while at the same time said system will request the user to input an identification code at least including the supplier number column 401 and its delivery site column 402 (as shown in the drawing, it may also include mode of delivery, purchasing staff code number, order number, buyer part number, seller part number, invoice date, invoice number., etc.), which enable the system to search for the requested order data corresponding to inputted identification code as well as other requirements from orders data file 32 of order database 30. In the case that the goods was delivered and a corresponding manifest is not issued, the user may select a supplement order column 403 to restrict automatically its searching range.

After inputting an identification code correctly, as illustrated in FIG. 4(B), user may select a required order by clicking on “select” column 404, in which a delivery volume column 405 and a packaging mode column 406 are compulsory to fill in; while the invoice date column 407 and invoice number column 408 are of selective information to input.

After adding a manifest as illustrated in FIG. 4(C), the system will display detailed contents of the requested manifest for allowing the user to browse online, in which the “send” mode column 409 “N” indicates that said manifest is not sent yet; if it indicates “Y” which means said manifest was delivered.

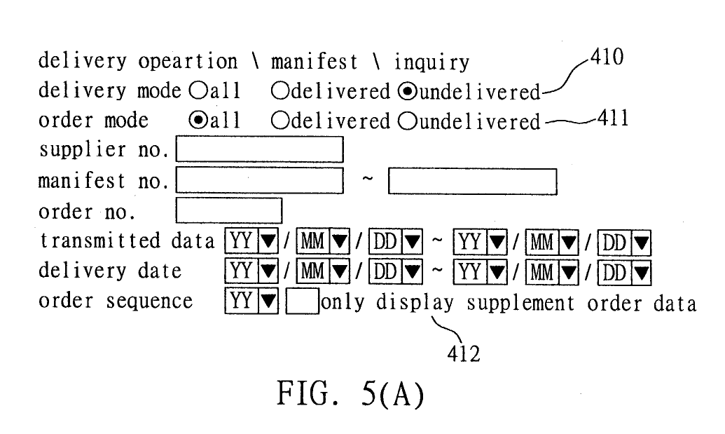

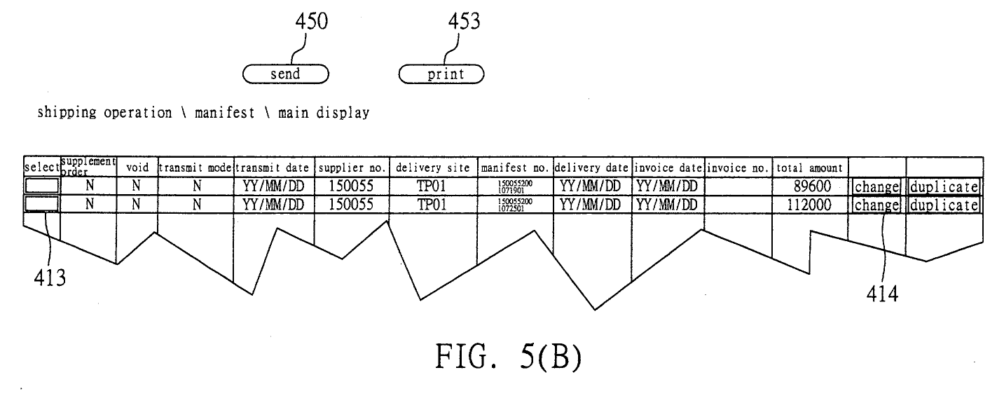

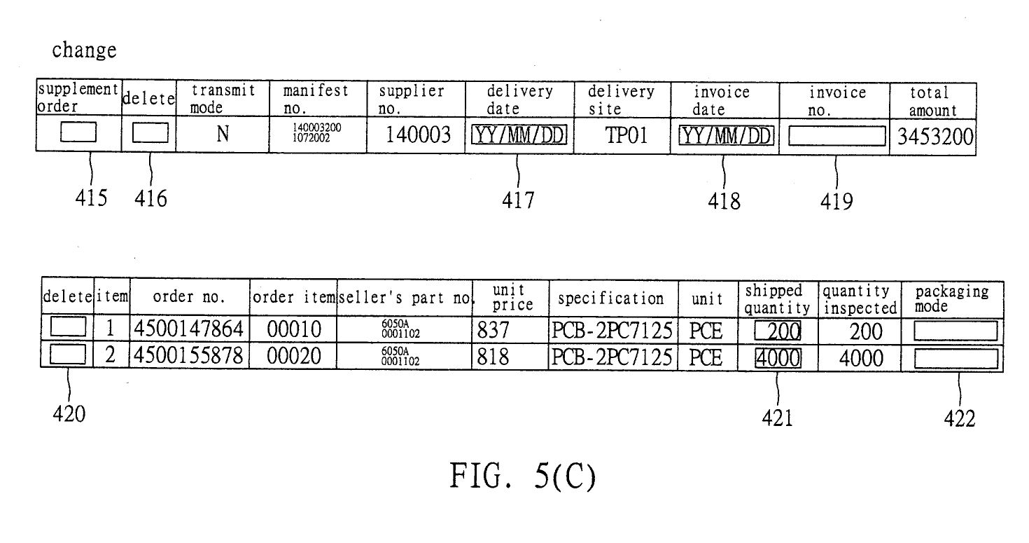

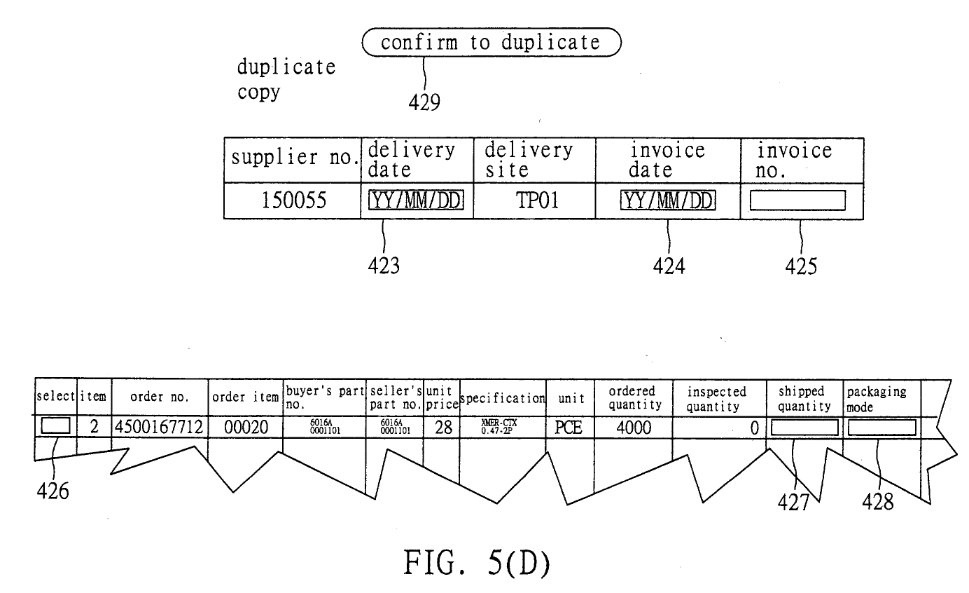

As illustrated in FIG. 5(A), when a user wishes to proceed modifications of a manifest, it first enters into an enquiry web page of the manifest, in which the “send” mode column 410, a manifest condition column 411 and a supplement manifest column 412 are provided for allowing the user to limit the inquiring range. In addition said system further displays including supplier number, manifest delivery number, order number, date of transmission, date of delivery and order sequence waiting code columns for allowing the user to make inquiry accordingly.

As illustrated in FIG. 5(B), said system displays a main file screen of the manifest, in which a select column 413 is provided for allowing the user to select required manifest for correcting, and after the manifest being selected the user then clicks on “change” column 414 to proceed with correction of the manifest.

As illustrated in FIG. 5(C), which shows detailed contents of the manifest being selected by the user, in which items such as a supplement column 415, delete column 416, date of delivery column 417, date of invoice column 418, invoice number column 419, a delete column 420, delivery volume column 421 and packaging mode column 422 are provided for allowing user to proceed with corrections if necessary.

As illustrated in FIG. 5(D), in which it displays when a user enters into a web page for duplication, user may proceed to add items into the manifest such as a date of delivery column 423, an invoice date column 424, an invoice number column 425, a selecting column 426, a delivery volume column 427 and a packaging mode column 428., etc., after confirming the items details the user may click a “copy” column for duplication of the manifest.

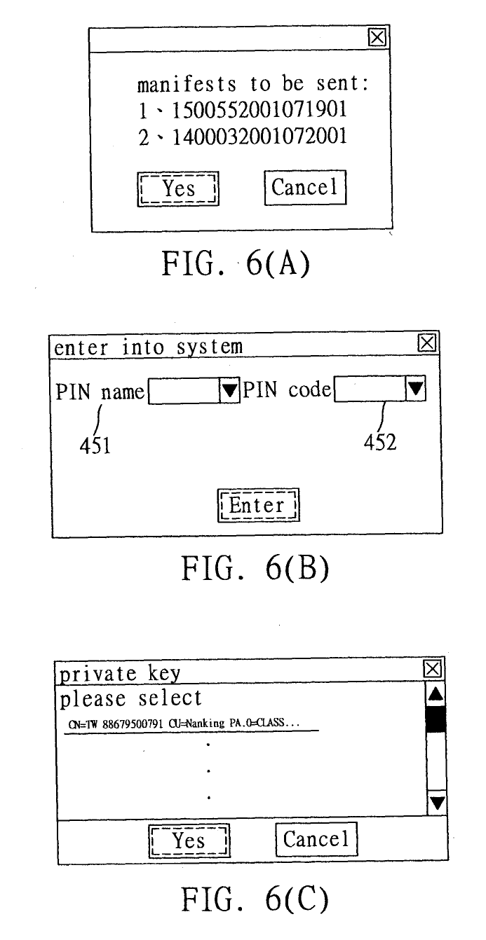

When a user intends to deliver a manifest online and in real-time, as illustrated in FIG. 5(B), user needs only to choose a “select” column 413 from a main screen of manifest to send out the manifest by clicking “send” column 450; next, as illustrated in FIG. 6(A), the system will display a list of manifests to be sent, user may choose to confirm or to cancel the action, and then the system will request the user to enter a personal identification number (PIN) on a name column 415 and input a personal identification number (PIN) password column 452 for identifying the user, as illustrated in FIG. 6(B). Lastly, as illustrated in FIG. 6(C), the system will display a private key selecting screen for the user to select the content of the private key and confirm the item in order to send the selected manifest to the buyer.

When a user wishes to print out a manifest online, as illustrated in FIG. 5(B), user needs only to choose a select column 413 from main screen of the manifest to print out the selected manifest, subsequently clicks a print item column 453 to proceed.

In summary, the method and system for online and real-time editing and forwarding manifests for use in manifest operation enable the user to operate in simply steps to add, inquiry, change, transmit and print out the manifest online and in real-time via the network communication system. The proposed method and system are not only capable of eliminating repetition of data-inputting and waste of time and human source in delivering commercial documents between both sides; it also can be responsive to clients' requirements in an online and real-time manner to grasp the first business opportunity.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for online and real-time editing and forwarding manifests, for being applied to a manifest editing and forwarding system, so as to allow a user at a terminal device to read and edit a manifest in an online and real-time manner via linkage from a browsing module of the terminal device to a network communication system, by which a product flow processing workstation of the manifest editing and forwarding system establishes an order data file corresponding to each purchase order, each order data file being designated with a unique identification code and stored in an order database, and a database server responds to a request from the user to search, edit and forward the manifest, the method comprising the steps of:
inputting an identification code of an inquired order data file from the user through the use of the browsing module of the terminal device via the network communication system;
searching via a searching module of the database server for an order data file corresponding to the inputted identification code;
displaying the searched order data file via the database server;
editing the displayed order data file via the user in an online and real-time manner through the use of the terminal device; and
confirming and forwarding the edited order data file to a buyer who makes a purchase order in association with the order data file.

2. The method of claim 1, wherein the manifest editing and forwarding system comprises:
a data searching module for searching the order data file from the order database corresponding to the identification code input by the user, for allowing the user to access order details from the searched order data file;
a data editing module for allowing the user to edit the order data file searched by the data searching module; and
a manifest delivering module for forwarding the edited order data file as a manifest from the data editing module to the buyer.

3. The method of claim 1, wherein the network communication system is Internet.

4. The method of claim 1, wherein the network communication system is an intranet.

5. The method of claim 1, wherein the network communication system is an extranet.

6. A system for online and real-time editing and forwarding manifests, for allowing a user at a terminal device to edit and forward a manifest in an online and real-time manner via linkage from a browsing module of the terminal device to a network communication system, the system for online and real-time editing and forwarding manifests comprising:
a product flow processing workstation for establishing an order data file corresponding to each purchase order generated from a buyer;
an order database for storing the order data files established by the product flow processing workstation; and
a database server for allowing the user at the terminal device to access the order data files stored in the order database; in the case of the database server receiving an identification code input from the user, the database server searching from the order database for an order data file corresponding to the input identification code and forwarding the searched order data file to the user.

7. The system of claim 6, wherein the database server further comprises:
a data searching module for searching the order data file from the order database corresponding to the identification code input by the user, for allowing the user to access order details from the searched order data file;
a data editing module for allowing the user to edit the order data file searched by the data searching module; and
a manifest delivering module for forwarding the edited order data file as a manifest from the data editing module to the buyer.

8. The system of claim 6, wherein the network communication system is Internet.

9. The system of claim 6, wherein the network communication system is an intranet.

10. The system of claim 6, wherein the network communication system is an extranet.
